(19) United States
(12) Patent Application Publication
(10) Pub. No.: US 2018/0287536 A1
(43) Pub. Date: Oct. 4, 2018

(54) METHOD FOR CONTROLLING A SYNCHRONOUS ELECTRIC MACHINE WITH A WOUND ROTOR

(71) Applicant: RENAULT s.a.s., Boulogne-Billancourt (FR)

(72) Inventors: Mohamad KOTEICH, Orsay (FR); Abdelmalek MALCOUM, Chevilly La Rue (FR); Gilles DUC, Bullion (FR); Guillaume SANDOU, Gometz La Ville (FR)

(73) Assignee: RENAULT s.a.s., Boulogne-Billancourt (FR)

(21) Appl. No.: 15/524,423

(22) PCT Filed: Oct. 26, 2015
(86) PCT No.: PCT/FR2015/052873

§ 371 Date: May 4, 2017

(30) Foreign Application Priority Data
Nov. 28, 2014 (FR) 1461121

(51) Int. Cl. H02P 21/13; H02P 21/18

(52) U.S. Cl. CPC H02P 21/13; H02P 21/18

(57) ABSTRACT

A method for controlling a synchronous electric machine with a wound rotor for an electric or hybrid motor vehicle includes measuring the rotor and stator phase currents and voltages in the three-phase reference frame and determining the rotor and stator phase currents and voltages in the two-phase reference frame according to the measurements of current and voltage in the three-phase reference frame. The method also includes determining the position and the speed of the rotor in relation to the stator by an observer according to the stator and rotor voltages and currents expressed in the two-phase reference frame, and the observer is regulated by a discrete extended Kalman algorithm.

The technical field of the invention is the control of electric machines and more particularly the control of synchronous electric machines with a wound rotor.

The advanced control of three-phase electric machines requires a good knowledge of the position of the machine rotor. To achieve this, a position sensor, called a resolver, is connected onto the motor shaft. The value of the measured rotor angle is sent to the controller that controls the motor. For several reasons (cost, reliability, space requirement, etc.), it is sought to eliminate mechanical sensors, and to replace them with software sensors (observers/estimators) which estimate the position and speed of the motor from electrical measurements (currents and voltages). Indeed, electrical sensors are much less expensive and less space-consuming than mechanical sensors. As they are essential to the operation of the motor for several reasons (operating safety, current loop servo control, etc.), it is sought to use the presence of same, to replace mechanical sensors with software sensors (algorithms), which, from measuring currents, estimate the position and speed of the rotor with great accuracy.

The present document focuses in particular on the case of three-phase synchronous machines with a wound rotor.

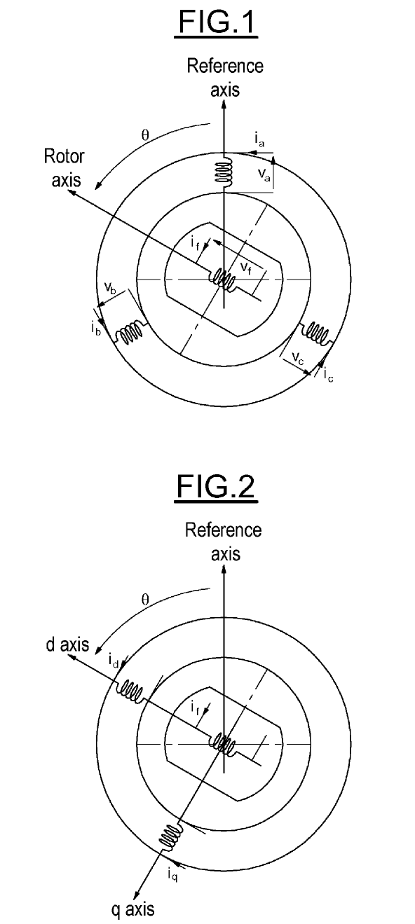

A synchronous motor with a wound rotor includes a three-phase stator and a wound rotor. The three-phase stator (phases a, b and c) is constructed so as to generate a rotating magnetic field. The wound rotor comprises a winding powered by a DC current (phase f). The amplitude of the field created in the air gap is variable and is adjustable through the supply current of the rotor. The rotor coil is therefore an electromagnet which seeks to align with the rotating magnetic field produced by the stator. The rotor rotates at the same frequency as the stator currents, which is why it is called a “synchronous” machine. The equivalent diagram of the motor in the three-phase reference frame is illustrated in FIG. 1.

The stator self- and mutual-inductances depend on the position θ of the non-cylindrical (“salient pole”) rotor. The machine is controlled in the Park reference frame, which is the transform of the fixed stator reference frame by a rotation transformation. Such a transformation requires knowledge of the value of the rotor angle θ. The Park transformation matrix which transforms the three-phase quantities (voltages vₐ, v_{b}, v_{c} and associated currents iₐ, i_{b}, i_{c}) into DC quantities (voltages v_{d}, v_{q}, v₀ and currents i_{d}, i_{q}, i₀ on the reference frame (d,q,0)) is:

$$P ( θ ) = [ \begin{matrix}cos θ & cos ( θ - \frac{2 π}{3} ) & cos ( θ + \frac{2 π}{3} ) \\ - sin θ & - sin ( θ - \frac{2 π}{3} ) & - sin ( θ + \frac{2 π}{3} ) \\ \frac{\sqrt{2}}{2} & \frac{\sqrt{2}}{2} & \frac{\sqrt{2}}{2}\end{matrix} ] \qquad ( Eq . 1 )$$

The equivalent diagram of the motor in the Park reference frame is illustrated in FIG. 2 (the homopolar components are zero since the three-phase system is balanced).

Estimation techniques, used for this motor, are electronic techniques, based on the injection of high-frequency voltages/currents in the stator or rotor phases, which require additional operations (filtering, demodulation, etc.).

Passive observation techniques (based on the observer in automatic control theory), less complex to implement from the electronics point of view, suffer from the loss of observability of the motor at low speed and at zero speed. For this reason, observers have not been found for this machine in the prior art.

One problem to be solved is to replace the mechanical position and speed sensor with a software sensor.

Another problem to be solved is to maintain an observability at low speed or at zero speed.

The following documents are known in the prior art.

Document US 2013/0289934A1 describes a method for estimating the flux of the stator from the voltage and current signals of the machine, then using this to estimate the rotor flux of the machine from the stator flux. The method also includes the determination of the electrical angle and its derivative. This method only applies to asynchronous machines and is not transposable to machines with a wound rotor.

Document US 2007/0194742A1 describes the estimation of the flux without involving an observer in the strict sense of the term, but rather with lagging sinusoidal signals.

Document CN102983806 describes a simple technique of stator flux estimation.

Document CN102437813 describes a method for establishing the rotor angle and speed from the rotor flux, for a permanent-magnet synchronous machine. Furthermore, the teaching of the document involves extensive use of physical filtering through an extraction of the fundamental of the rotor voltage and current.

One object of the invention is a method for controlling a synchronous electric machine with a wound rotor for an electric or hybrid motor vehicle. The method includes steps during which:

the currents and voltages are measured in the rotor and stator phases of the machine in a three-phase reference frame linked to the stator,

the currents and voltages are determined in the rotor and stator phases in a fixed two-phase reference frame linked to the stator according to the current and voltage measurements in the three-phase reference frame.

The method also includes steps during which the position and speed of the rotor are determined with respect to the stator by an observer according to the stator and rotor currents and voltages expressed in the fixed two-phase reference frame linked to the stator, and the observer is adjusted by a discrete extended version of a Kalman algorithm.

Adjusting the observer by a discrete extended version of a Kalman algorithm may include the following steps:

during a prediction phase, the state of the system and the covariance matrix of the error associated with the next iteration estimated at the current iteration are determined, according to the uncertainty covariance matrix of the system at the current iteration, the covariance matrix of the error at the current iteration, the state estimated at the current iteration and the linearized system at the current iteration,

the gain of the observer is determined at the current iteration according to the covariance matrix of the error on the state at the next iteration estimated at the current iteration, the covariance matrix of measurement noise at the current iteration and the linearized system at the current iteration, and

the state of the system at the next iteration is updated according to the latest determined measurements, the corresponding estimated quantities, the gain of the observer at the current iteration, and the state at the next iteration estimated at the current iteration.

The dynamics of the observer may be increased when the values of the covariance matrix of noise of the system are increased.

The accuracy of the observer may be increased in spite of the speed, when the values of the covariance matrix of measurement noise are increased.

When the speed is below a threshold, a high-frequency, low intensity current may be injected into the rotor winding, in order to make the system observable and then determine the position and speed thanks to the extended version of the Kalman algorithm.

The method for control has the advantage of a reduced cost due to the absence of mechanical sensors, or to being able to operate in parallel with a less expensive and less accurate mechanical sensor than those generally used. This increases the reliability of control and also reduces the cost thereof.

The method for control also has the advantage of an estimation of the position at zero speed.

Other objects, features and advantages of the invention will appear on reading the following description, given solely as a non-restrictive example with reference to the accompanying drawings in which:

FIG. 1 illustrates the main elements of a synchronous electric machine with a wound rotor in a three-phase reference frame,

FIG. 2 illustrates the main elements of a synchronous electric machine with a wound rotor in the Park reference frame, and

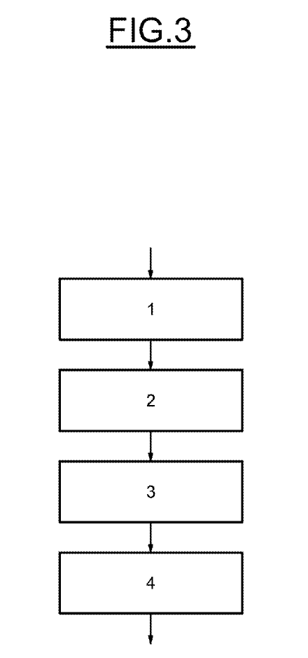

FIG. 3 illustrates the main steps of the method for control according to the invention.

Solving the technical problems addressed in the introduction is based on the machine model and on observer theory.

It is recalled that observer theory includes the concepts of observability and state observer.

Before initiating a procedure for designing an observer for a dynamic system, it is important and necessary to ensure that the state of the latter can be estimated from information on the input and output. The observability of a system is the property that allows it to be said whether the state can be determined solely from knowledge of the input and output signals.

Unlike linear systems, the observability of non-linear systems (like the synchronous machine with a wound rotor) is intrinsically linked to the inputs and to the initial conditions. When a non-linear system is observable, it may have inputs which make it unobservable (singular inputs) and preclude any observation strategy.

In automatic control and in information theory, a state observer is an extension of a model represented in the form of state representation. When the state of a system is not measurable, an observer is designed which can be used to reconstruct the state from a model of the dynamic system and the measurements of other states. State is understood to mean a set of physical values defining the observed system.

Multiple state observers may be used for controlling electric motors without a mechanical sensor, among which may be cited the Kalman filter that is used in a wide range of technological fields.

The model of the synchronous machine with a wound rotor is highly non-linear. This is due to the coupling between the dynamics of the stator and rotor currents, as well as the dependence of the stator inductances on position due to saliency.

The electric machine may be modeled in a two-phase reference frame (α,β) by performing the projections of the quantities of the three-phase reference frame (a,b,c) on a two-phase reference frame linked to the stator. The transformation matrix corresponding to such a projection is the following. Note that the homopolar components are not taken into account.

$${C}_{32} = [ \begin{matrix}1 & - 1 / 2 & - 1 / 2 \\ 0 & \sqrt{3} / 2 & - \sqrt{3} / 2\end{matrix} ] \qquad ( Eq . 2 )$$

The electromagnetic equations of the system in this reference frame may be written in the following way:

$${v}_{α} = {R}_{s} {i}_{α} + \frac{d {ψ}_{α}}{dt} \\ {v}_{β} = {R}_{s} {i}_{β} + \frac{d {ψ}_{β}}{dt} \\ {v}_{f} = {R}_{f} {i}_{f} + \frac{d {ψ}_{f}}{dt} \qquad ( Eq . 3 )$$

With:

v_{α}: the voltage applied to the stator on the α axis (corresponding to the voltage at the terminals of a two-phase winding equivalent to the three-phase windings on the α axis)

v_{β}: the voltage applied to the stator on the β axis

v_{f}: the rotor voltage

i_{α}:the current flowing in the stator on the α axis

i_{β}: the current flowing in the stator on the β axis

i_{f}: the rotor current

Ψ_{α}: the stator electromagnetic flux in the equivalent phase on the α axis

Ψ_{β}: the stator electromagnetic flux in the equivalent phase on the β axis

Ψ_{f}: the rotor electromagnetic flux

Rₛ: the stator resistance

R_{f}: the rotor resistance.

The fluxes are determined by the following equations:

ψ_{α}=L_{α}i_{α}+L_{αβ}i_{β}+M_{f}i_{f} cos θ

ψ_{β}=L_{αβ}i_{α}+L_{β}i_{β}+M_{f}i_{f} sin θ

ψ_{f}=M_{f}i_{α} cos θ+M_{f}i_{β} sin θ+L_{f}i_{f} (Eq. 4)

These equations may be rewritten in matrix form in the following way:

$$[ \begin{matrix}{ψ}_{α} \\ {ψ}_{β} \\ {ψ}_{f}\end{matrix} ] = [ L ( θ ) ] [ \begin{matrix}{i}_{α} \\ {i}_{β} \\ {i}_{f}\end{matrix} ] \qquad ( Eq . 5 )$$

With

$$[ L ( θ ) ] = [ \begin{matrix}{L}_{α} & {L}_{α β} & {M}_{f} cos θ \\ {L}_{α β} & {L}_{β} & {M}_{f} sin θ \\ {M}_{f} cos θ & {M}_{f} sin θ & {L}_{f}\end{matrix} ] \qquad ( Eq . 6 )$$

Where

L_{α} and L_{β}: the cyclic inductances of the α and β phases.

L_{f}: the self-inductance of the rotor winding.

M_{f}: the maximum mutual inductance between a stator phase and the rotor phase.

L_{αβ}: the mutual inductance between the stator phases.

Moreover the following relationships are known linking the cyclical inductances and the mutual inductance at the position θ.

L_{α}=L₀+L₂ cos 2θ

L_{β}=L₀−L₂ cos 2θ

L_{αβ}=L₂ sin 2θ (Eq. 7)

The mechanical equations of the electric machine are as follows:

$$J \frac{d ω}{dt} = {pC}_{m} - {pC}_{r} - {f}_{v} ω \qquad ( Eq . 8 )$$

With:

J: the inertia of the rotor with the load

p: the number of pairs of rotor poles

Cₘ and Cᵣ: the motor and resistant torques

fᵥ: the coefficient of viscous friction

ω=p*Ω

p: the number of poles of the machine

Ω: the rotation speed of the rotor

The motor torque is determined by the following equation:

$${C}_{m} = {\frac{3 p}{4} [ \begin{matrix}{i}_{α} \\ {i}_{β} \\ {i}_{f}\end{matrix} ]}^{T} \frac{d [ L ( θ ) ]}{d θ} [ \begin{matrix}{i}_{α} \\ {i}_{β} \\ {i}_{f}\end{matrix} ] \qquad ( Eq . 9 )$$

The electric machine is modeled in the following form:

$$\frac{dI}{dt} = {L ( θ )}^{- 1} ( V - {R}_{eq} I ) \\ \frac{d ω}{dt} = {J}^{- 1} ( {p}^{2} \frac{3}{4} {I}^{T} \frac{d L ( θ )}{d θ} I - {pC}_{r} - {f}_{v} ω ) \\ \frac{d θ}{dt} = ω \qquad ( Eq . 10 )$$

with

$$\begin{matrix}I = [ \begin{matrix}{i}_{α} \\ {i}_{β} \\ {i}_{f}\end{matrix} ] ; V = [ \begin{matrix}{v}_{α} \\ {v}_{β} \\ {v}_{f}\end{matrix} ] & ( Eq . 11 ) \\ {R}_{eq} = R + \frac{d [ L ( θ ) ]}{d θ} ω & ( Eq . 12 ) \\ R = [ \begin{matrix}{R}_{s} & 0 & 0 \\ 0 & {R}_{s} & 0 \\ 0 & 0 & {R}_{f}\end{matrix} ] & ( Eq . 13 )\end{matrix}$$

The system of equations Eq. 10 to Eq. 13 modeling the electric machine may be reformulated in the general form of non-linear systems:

$$\frac{dx}{dt} = f ( x , u ) \\ y = h ( x ) \qquad ( Eq . 14 )$$

With:

$$\begin{matrix}x = [ \begin{matrix}{i}_{α} \\ {i}_{β} \\ {i}_{f} \\ ω \\ θ\end{matrix} ] , & ( Eq . 15 ) \\ u = [ \begin{matrix}{v}_{α} \\ {v}_{β} \\ {v}_{f}\end{matrix} ] , and & ( Eq . 16 ) \\ y = [ \begin{matrix}{i}_{α} \\ {i}_{β} \\ {i}_{f}\end{matrix} ] = h ( x ) = C \cdot x = [ \begin{matrix}1 & 0 & 0 & 0 & 0 \\ 0 & 1 & 0 & 0 & 0 \\ 0 & 0 & 1 & 0 & 0\end{matrix} ] x & ( Eq . 17 )\end{matrix}$$

For the system modeled by the equations Eq. 14 to Eq. 17, an observer may be formalized by the following equation:

$$\frac{d}{dt} \hat{x} = f ( \hat{x} , u ) + K ( y - C \cdot \hat{x} ) \qquad ( Eq . 18 )$$

With

\hat{x}: the vector of the estimated states corresponding to the vector of state x defined by the equation Eq. 15

K: Gain of the observer

The choice of the gain K, which multiplies the error term allows the observer to be adjusted. This gain is calculated by the Kalman algorithm (discrete extended version).

In order to allow the numerical solution of the system, it is linearized in the following way.

$$\begin{matrix}{A}_{k} = \frac{\partial f}{\partial x} {\vert}_{{\hat{x}}_{k - 1} , {u}_{k}} & ( Eq . 19 ) \\ {H}_{k} = \frac{\partial h}{\partial x} {\vert}_{{\hat{x}}_{k - 1}} & ( Eq . 20 )\end{matrix}$$

Thus the analytical form of the matrices Aₖ and Hₖ is calculated which are, respectively, the Jacobians of functions f and h of the equation Eq. 14 with respect to the vector x. These matrices are very complex so that they cannot be written here. They are determined by symbolic calculation and transcribed directly into the method.

The method begins when the currents and voltages of the electric machine have been measured in the three-phase reference frame and converted into the two-phase reference frame by applying the matrix Eq. 2.

During a first step 1, use is made of the values of the states (currents, speed and position) of the previous iteration and the voltages measured for calculating the values of the matrices Aₖ and Hₖ according to the linearized expressions of same (Eq. 19 and Eq. 20).

During a second step 2, a prediction phase is performed during which the state of the system is determined at the next iteration according to the data available at the current iteration. The following equations are used to perform this prediction phase:

\hat{x}_{k+1/k}=\hat{x}_{k/k}+Tₛf(\hat{x}_{k/k},uₖ)

P_{k+1/k}=P_{k/k}+Tₛ(AₖP_{k/k}+P_{k/k}Aₖ^{T})+Qₖ (Eq. 21)

With

Tₛ: sampling period

P_{k/k}: covariance matrix of the error on the state at iteration k estimated at iteration k

kP_{k+1/k}: covariance matrix of the error on the state at iteration k estimated at iteration k+1

Qₖ: covariance matrix of the uncertainties of the system at iteration k

k: the iteration number

The covariance matrix of the uncertainties of the system Qₖ reports the uncertainties in the definition of the system, e.g. due to insufficient knowledge of the system, to the modeling approximation of the system, or to the uncertainty regarding the values used in modeling.

In other words, during this step, the state x of the system at iteration k+1 estimated at iteration k is determined notably according to the state of the system at iteration k estimated at iteration k.

During a third step 3, the gain of the observer is then calculated:

Kₖ=P_{k+1/k}Hₖ^{T}(HₖP_{k+1/k}Hₖ^{T}+Rₖ)⁻¹ (Eq. 22)

With

Rₖ: covariance matrix of measurement noise at iteration k

Finally, during a fourth step 4, a phase of a posteriori updating is performed during which the state of the system at iteration k+1 estimated at iteration k+1 is updated thanks to the information of the latest measurements y and the corresponding estimated quantities h(x) according to the state of the system at iteration k+1 determined at iteration k. The function h(x) depends directly on the modeling of the system (cf Eq. 14). The following system of equations reports this phase of updating.

\hat{x}_{k+1/k+1}=\hat{x}_{k+1/k}+Kₖ.(y−h(\hat{x}_{k+1/k}))

P_{k+1/k+1}=P_{k+1/k}−K_{K}Hₖ.P_{k+1/k} (Eq.23)

During this step, the state x of the system at iteration k+1 estimated at iteration k+1 is determined by correcting the state x of the system at iteration k+1 estimated at iteration k according to the gain and an error term dependent on the covariance matrix of the error on the state at iteration k+1 estimated at iteration k and the matrix Hₖ, an analytical form of the Jacobian of the function h.

Estimates of the speed and position are then obtained which are reused for the next iteration in the observer.

These estimates are also transmitted to the control of the electrical machine (to the servo controller or loops).

The steps in the method described above are repeated in order to have regularly updated position and speed values.

The filter is adjusted by the choice of the matrices Qₖ and Rₖ which are often taken as constant. The matrix Pₖ must be initialized, however, the initial values chosen only affect the first iteration and do not have notable consequences on the conduct of the method. The choice of the matrices depends on the system to be observed, the parameters of the motor and the environment in which the motor is operating (measurement noise). There is no systematic method, but the general rules are:

If the values of Qₖ are increased, less confidence is placed in the measurements, and the observer dynamics becomes more rapid.

If the values of the matrix Rₖ are increased, more confidence is placed in the measurements, which increases accuracy in spite of the speed.

As a general rule, the matrices Qₖ and Rₖ are likely to see their values modified from one iteration k to the next. However, the present application does not require such a modification. Consequently, the matrices Qₖ and Rₖ are held constant.

The following matrices are used in the present case:

$$\begin{matrix}{Q}_{k} = [ \begin{matrix}1 & 0 & 0 & 0 & 0 \\ 0 & 1 & 0 & 0 & 0 \\ 0 & 0 & 1 & 0 & 0 \\ 0 & 0 & 0 & 200 & 0 \\ 0 & 0 & 0 & 0 & 5\end{matrix} ] & ( Eq . 24 ) \\ {R}_{k} = [ \begin{matrix}1 & 0 & 0 \\ 0 & 1 & 0 \\ 0 & 0 & 1\end{matrix} ] & ( Eq . 25 )\end{matrix}$$

As has been explained in the introduction, the estimation of the state of the system by an observer may not be used at low or zero speed.

The observability study of the machine at zero speed provides the following observability condition.

The determinant of the observability matrix must be non-zero. The calculation of the determinant is a difficult task because of the complexity of the equations. The determinant is:

$${Δ}_{\vert ω = 0} = \frac{2 {L}_{2} {L}_{f} - {M}_{f}^{2}}{{L}_{q} ( {M}_{f}^{2} - {L}_{d} {L}_{f} )} [ ( {M}_{f} {i}_{f} + 2 {L}_{2} {i}_{d} ) \frac{{di}_{q}}{dt} - ( 2 {L}_{2} \frac{{di}_{d}}{dt} + {M}_{f} \frac{{di}_{f}}{dt} ) {i}_{q} ] \qquad ( Eq . 26 )$$

With:

L_{d}=L₀+L₂

L_{q}=L₀−L₂

i_{d}=i_{α} cos θ+i_{β} sin θ

i_{q}=−i_{α} sin θ+i_{β} cos θ

At zero speed (θ=constant), and at constant currents i_{d}, i_{q} and i_{f}, the determinant of the observability matrix is zero. The observability of the machine cannot be ensured. The observability condition is sufficient but not necessary. Thus it appears that the observability on the position is lost but that the speed still remains well estimated.

The solution provided for addressing the problem of loss of observability is to inject a HF (high frequency) current into the rotor winding, so as to have a non-zero derivative of the current i_{f}. This is achieved in a step, during which it is determined whether the estimated speed is below a threshold and if such is the case, a high frequency current is injected into the rotor winding. Such an injection may also be performed at the startup of the system to ensure a good estimate of the speed and position. The determinant of the observability matrix at zero speed is then non-zero and the position may be estimated. This is done during a step 3. For example, if the speed is less than 10 rad/sec, a current of amplitude 50 mA and frequency 10 kHz is injected into the rotor coil. After injection of the current, the position is determined at rest.

The synthesis is made of a state observer based on the machine model. The observability condition at zero speed shows that the motor loses observability if the currents i_{d}, i_{q} and i_{f} are constant. The solution provided for ensuring observability at zero speed is to inject a low-amplitude (of the order of tens of mA), high-frequency (of the order of tens of kHz) current into the rotor winding when the speed goes below a certain threshold approaching zero, in order to find the observability of the position.

1-5. (canceled)

6. A method for controlling a synchronous electric machine with a wound rotor for an electric or hybrid motor vehicle, the method comprising:
measuring currents and voltages in rotor and stator phases of the machine in a three-phase reference frame linked to a stator;
determining the currents and voltages in the rotor and stator phases in a fixed two-phase reference frame linked to the stator according to the current and voltage measurements in the three-phase reference frame;
determining a position and speed of the rotor with respect to the stator by an observer according to the currents and voltages in the stator and rotor phases expressed in the fixed two-phase reference frame; and
adjusting the observer by a discrete extended version of a Kalman algorithm.

7. The method as claimed in claim 6, in which the adjusting the observer includes the following steps:
during a prediction phase, a state of a system and a covariance matrix of an error associated with a next iteration estimated at a current iteration are determined, according to an uncertainty covariance matrix of the system at the current iteration, the covariance matrix of the error on the state at the current iteration, the state estimated at the current iteration and a linearized system at the current iteration,
a gain of the observer is determined at the current iteration according to the covariance matrix of the error on the state at the next iteration estimated at the current iteration, a covariance matrix of measurement noise at the current iteration and the linearized system at the current iteration, and
the state of the system at the next iteration is updated according to the latest determined measurements, corresponding estimated quantities, the gain of the observer at the current iteration, and the state at the next iteration estimated at the current iteration.

8. The method as claimed in claim 7, in which dynamics of the observer are increased by increasing the values of the covariance matrix of noise of the system.

9. The method as claimed in claim 7, in which an accuracy of the observer is increased in spite of the speed, by increasing the values of the covariance matrix of measurement noise.

10. The method as claimed in claim 6, in which, when the speed is below a threshold, a high-frequency, low intensity current is injected into the rotor winding, in order to make the system observable, then the position and speed are determined thanks to the extended version of the Kalman algorithm.
